(19) United States
(12) Patent Application Publication
(10) Pub. No.: US 2015/0267529 A1
(43) Pub. Date: Sep. 24, 2015

(54) Eigen Mode Transmission of Signals

(71) Applicants: Homi Phiroze COOPER, (US); Roger Lee SHELTON, (US); Carl DODGE, (US); HALLIBURTON ENERGY SERVICES, INC., Houston, TX (US)

(72) Inventors: Homi Phiroze Cooper, Houston, TX (US); Roger Lee Shelton, Houston, TX (US); Carl Dodge, Houston, TX (US)

(73) Assignee: Halliburton Energy Services, Inc., Houston, TX (US)

(21) Appl. No.: 14/438,304

(22) PCT Filed: Feb. 4, 2013
(86) PCT No.: PCT/US13/24570

§ 371 Date: Apr. 24, 2015

(51) Int. Cl. E21B 47/12; H02J 4/00

(52) U.S. Cl. CPC E21B 47/12; H02J 4/00

(57) ABSTRACT

An apparatus includes a logging cable with exactly 3 conductors and an armor. A first transceiver is coupled to the three conductors and the armor of the logging cable. The first transceiver comprises a first-transceiver mode M1 port, a first-transceiver mode M2 port, and a first-transceiver mode M3 port. The first transceiver couples to a first mode on the three conductors and the armor of the logging cable corresponding to a signal on one of the first-transceiver ports, a second mode on the three conductors and the armor of the logging cable corresponding to a signal on one of the first-transceiver ports, and a third mode on the three conductors and the armor of the logging cable corresponding to a signal on one of the first-transceiver ports. The first mode, the second mode, and the third mode are mutually orthogonal.

### BACKGROUND

In a multi-conductor logging cable, it is fairly easy to separate direct current (“DC”) currents simply by using separate conductors. This is because DC currents do not couple into closely adjacent conductors. However when higher frequency alternating current (“AC”) currents (such as are present in telemetry signals) are carried over the logging line, the situation is more complex because electrical conductors in close proximity over long lengths exhibit strong coupling (both capacitive and inductive) between adjacent conductors. In fact, if an AC signal is applied to a first conductor and armor at one end of a multi-conductor logging cable, measurement at the other end of about 30 thousand feet of multi-conductor cable will show that all of the signal power has transferred to adjacent conductors at certain frequencies. The exact frequency at which this power transfer takes place depends on the length of the cable as well as the type of logging cable. Such signal dropout caused by the tight mutual coupling between conductors is problematic for broadband high speed telemetry signals.

### BRIEF DESCRIPTION OF THE DRAWINGS

FIG. 1 shows a wireline well logging system.

FIGS. 2A and 2B show cross-sections of a 3-conductor logging cable.

FIGS. 3-5 illustrate circuits that can be used to excite eigen modes in a 3-conductor logging cable.

FIG. 6 illustrates a system that can excite a plurality of eigen modes in a 3-conductor logging cable.

FIGS. 7-10 illustrate ways that different configurations of eigen mode transmission of signals can be used.

FIG. 11 illustrates an environment.

### DETAILED DESCRIPTION

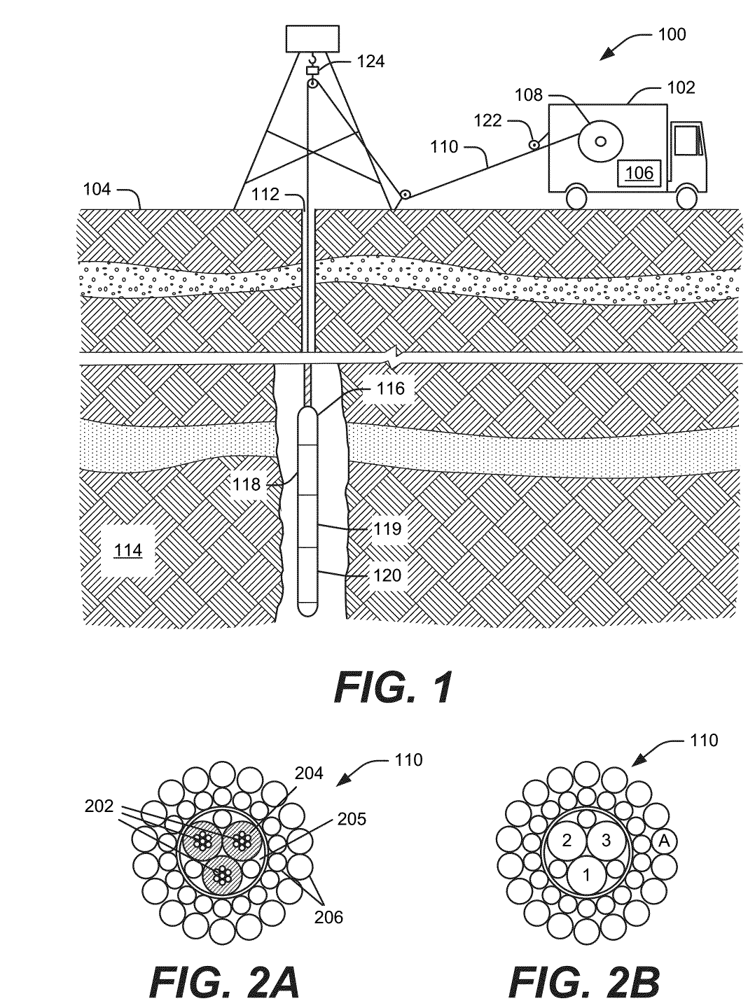

In one embodiment of a wireline well logging system 100 at a well site, as depicted in FIG. 1, a logging truck or skid 102 on the earth's surface 104 houses a data gathering computer 106 and a winch 108 from which a logging cable 110 extends into a well bore 112 drilled into a formation 114.

In one embodiment, the logging cable 110 suspends a logging toolstring 116 within the well bore 112 to measure formation data as the logging toolstring 116 is raised or lowered by the logging cable 110. In one embodiment, the logging toolstring 116 is conveyed into the well bore 112 by coiled tubing (not shown). In one embodiment, in which the well bore 112 is a deviated well, the logging toolstring 116 is conveyed into the well bore 112 by a tractor (not shown). In one embodiment, the logging toolstring 116 includes a variety of sensors and actuators, such as sensor 118, sensor 119, and sensor 120.

In one embodiment, in addition to conveying the logging toolstring 116 into the well, the logging cable 110 provides a link for power and communications between the surface equipment, e.g., data gathering computer 106, and the logging toolstring 116.

In one embodiment, as the logging tool 116 is raised or lowered within the well bore 112, a depth encoder 122 provides a measured depth of the extended cable 110. In one embodiment, a tension load cell 124 measures tension in the logging cable 110 at the surface 104.

The AC coupling between conductors described above may be reduced on the order of 1000 times over all frequencies by using symmetrical sets of conductors to conduct the desired AC currents. In one embodiment, the logging cable 110 with symmetrical conductors, shown in cross-section in FIG. 2A, includes three conductors 202. In one embodiment, each of the conductors 202 is surrounded by an insulating jacket 204. The insulated conductors are bundled together in a semiconductive wrap 205, which is surrounded by two layers of counterwound metal armor wire 206. Being made of metal, the armor wires 206 are conductive and may be used as a fourth conductor. FIG. 2B shows a cross-section of the logging cable 110 of FIG. 2A having its conductors labeled 1-3 and its armor labeled A. In one embodiment, the properties of the cable conductors are well matched so that the difference between the resistance of any conductor with respect to any other conductor is less than 2%. Additionally, in one embodiment the capacitance of any conductor to armor does not vary from the capacitance of any other conductor to armor by more than 2% The notations used in FIG. 2B will be used in the following discussions.

A 3-conductor logging cable, such as that shown in FIGS. 2A and 2B, could be advantageous over the more commonly-used 7-conductor cable such as that illustrated in U.S. Pat. No. 7,081,831, in situations in which the slenderness of the 3-conductor logging cable is preferable. For example, a 3-conductor cable might be preferred in a slickline operation where slender cables are useful but it is also desired to power down-hole motors from the surface.

Choosing symmetrical sets of conductors to pass electrical currents is known as mode transmission. Mode transmission is based on determining the eigenvectors or the proper symmetrical set of conductors which will pass signal and/or power currents over a multi-conductor logging line. Generally for a multi-conductor logging line with N conductors equally spaced from the center of the cable, such as logging cable 110 shown in FIGS. 2A and 2B, there are N symmetrical connections that provide N independent paths for AC signals. Usually only one of these paths is a direct connection to the electrical conductors. This single “direct connection” path can be used to provide AC or DC power from the surface to the downhole equipment or it can be used to provide a telemetry connection between the surface equipment, e.g., data gathering computer 106, and the tools below, e.g. sensors 118, 119, 120.

Eigen mode transmission involves superimposing several signals on each of the conductors of a multi-conductor cable. For a 3-conductor cable the three vertical columns in Table 1 define an acceptable set of orthogonal eigen functions for power & telemetry transmission.

TABLE 1

| | Mode 1 | Mode 2 | Mode 3 |
|---|---|---|---|
| Conductor 1 | 1 | 1 | −1 |
| Conductor 2 | 1 | −1 | −1 |
| Conductor 3 | 1 | 0 | +2 |

It can be seen that the dot product of the Mode 1 (column 1) with Mode 2 (column 2) is zero; similarly the dot product of the Mode 2 (column 2) with Mode 3 (column 3) is zero, and the dot product of the Mode 1 (column 1) with Mode 3 (column 3) are both zero. Thus, the vectors represented by these columns are mutually orthogonal to each other.

In one embodiment, Mode 1 , called the “common” mode, is excited by the circuit shown in FIG. 3. In one embodiment, a source 302, which could be an AC power source, a DC power source, or a telemetry signal source, is coupled through a 3-conductor logging cable 304 to a load 306. In one embodiment, the 3-conductor logging cable 304 includes three conductors (1, 2, and 3) and an armor arranged as shown in FIGS. 2A and 2B. In one embodiment, one leg of the source 302 is tied to all three conductors and the other leg is tied to the armor. As a result, the source 302 excites Mode 1 in the logging cable 304 as shown in Table 1 above.

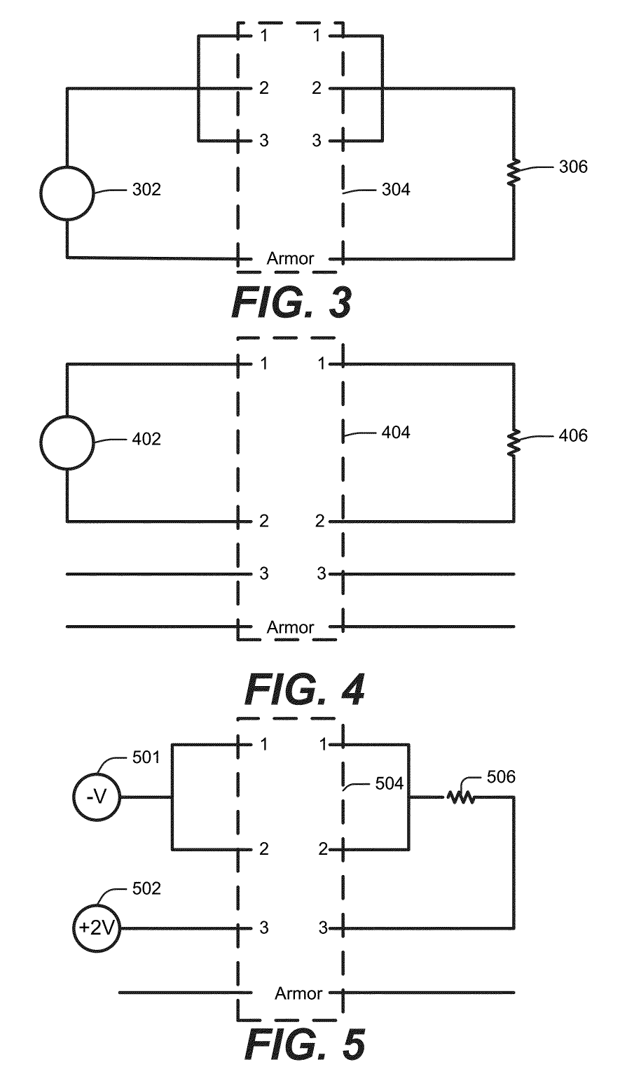

In one embodiment, Mode 2 is excited by the circuit in FIG. 4. In one embodiment, a source 402, which could be an AC power source, a DC power source, or a telemetry signal source , is coupled through a 3-conductor logging cable 404 to a load 406. In one embodiment, the 3-conductor logging cable 404 includes three conductors (1, 2, and 3) and an armor arranged as shown in FIGS. 2A and 2B. In one embodiment, one leg of the source 402 is tied to conductor 1 and the other leg is tied to conductor 2. The source 402 is not tied to conductor 3 or to the armor. As a result, the source 402 excites Mode 2 in the logging cable 304 as shown in Table 1 above.

In one embodiment, Mode 3 is excited by the circuit in FIG. 5. In one embodiment, a −V DC source 501 and a +2V DC source 502 are coupled through a 3-conductor logging cable 504 to a load 506. In one embodiment, the 3-conductor logging cable 404 includes three conductors (1, 2, and 3 ) and an armor arranged as shown in FIGS. 2A and 2B. In one embodiment, the −V DC source 501 is coupled to conductor 1 and conductor 2 and the +2V DC source 502 is coupled to conductor 3. In one embodiment, one leg of the load 506 is coupled to conductor 1 and conductor 2 and the other leg of the load 506 is coupled to conductor 3. As a result the DC sources 501 and 502 excite Mode 3 in the logging cable 404 as shown in Table 1 above.

The challenge is to connect the circuits shown in FIGS. 3, 4, and 5 simultaneously.

In one embodiment, the simultaneous connections are accomplished through the use of multifilar transformers. Multifilar transformers are manufactured with multiple secondary windings with exactly the same number of turns. Thus, in one embodiment, using a multifilar transformer with four secondary windings, mode 3 is excited by connecting the negative end of secondary winding 1 to conductor 1, the negative end of secondary winding 2 to conductor 2, and the positive end of the series connection of secondary winding 3 and secondary winding 4 (to give a weight of 2) to conductor 3. In one embodiment, the positive end of secondary winding 1 and the positive end of secondary winding 2 connect to the negative end of the series combination of secondary winding 3 and secondary winding 4.

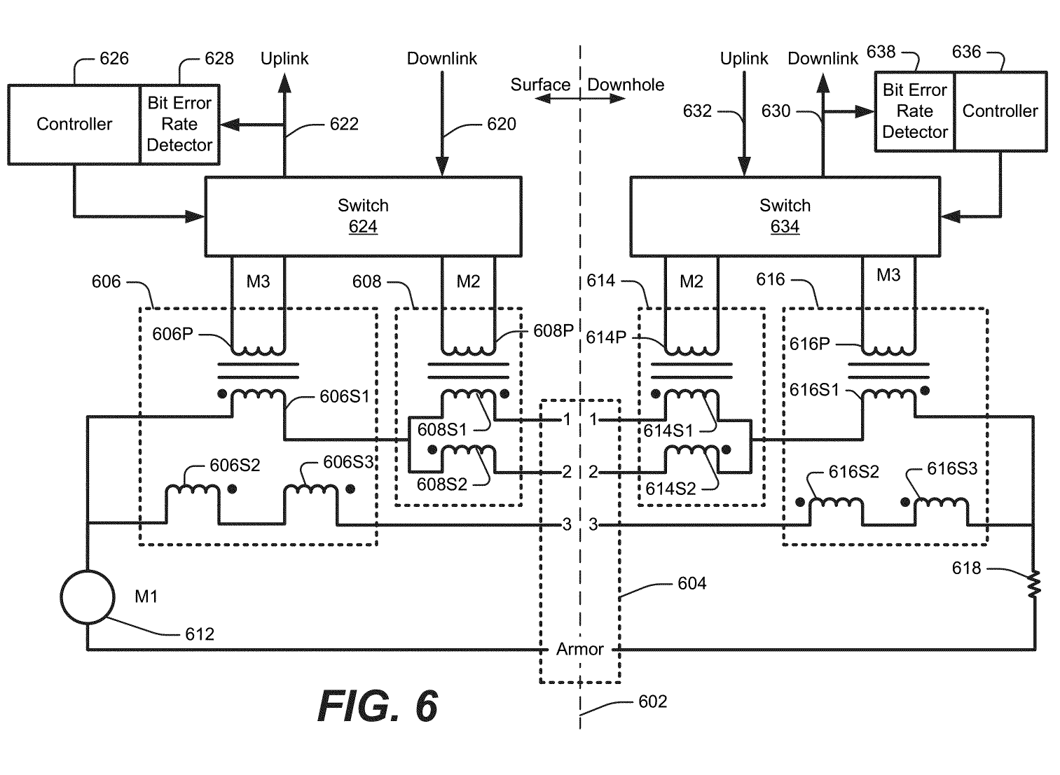

In one embodiment, shown in FIG. 6, a circuit uses multifilar transformers to provide the eigen modes shown in Table 1 over a 3 conductor logging cable. FIG. 6 illustrates surface equipment to the left of dashed line 602 and downhole equipment to the right of dashed line 602. 3-conductor logging cable 604 connects the surface equipment to the downhole equipment.

In one embodiment, the circuit in FIG. 6 allows bi-directional communication. That is, the equipment on the surface can transmit information to the downhole equipment and the downhole equipment can transmit information to the surface equipment. In one embodiment, the equipment on the surface transmits in one mode (e.g., mode M3) while the downhole equipment transmits in another mode (e.g., mode M2) and power is delivered from the surface to the downhole equipment in yet another mode (e.g., mode M1).

In one embodiment, the 3-conductor logging cable 604 shown in FIG. 6 includes 3 conductors (conductor 1, conductor 2, and conductor 3 ) and an armor arranged as shown in FIGS. 2A and 2B. In one embodiment, the surface equipment includes a first multifilar transformer 606 that includes a primary winding 606P and three secondary windings 606S1, 606S2, and 606S3. In one embodiment, two of the secondary windings 606S2 and 606S3 are connected in series. In one embodiment, the polarity of secondary winding 606S1 (indicated by the dot adjacent the winding) is opposite the polarity of the combined secondary windings 606S2 and 606S3.

In one embodiment, the surface equipment also includes a second multifilar transformer 608 that includes a primary winding 608P and two secondary windings 608S1 and 608S2. In one embodiment, the polarity of secondary winding 608S1 is opposite the polarity of secondary winding 608S2.

In one embodiment, when the surface equipment is transmitting in the M3 mode, the signal present on the primary winding 606P of multifilar transformer 606 (i.e., at the M3 port) will appear across secondary winding 606S1 with a polarity −P and a first amplitude A, depending on the amplitude of the signal present on the primary winding 606P and the ratio of the number of turns in secondary winding 606S1 to the number of turns in primary winding 606P (in one embodiment, the ratio is 1). That signal will appear at conductors 1 and 2 through the secondary windings of multifilar transformer 608 (discussed below) at the same amplitude A and polarity P, although the current exiting the secondary winding 606S1 will be divided between conductor 1 and conductor 2. In one embodiment, the signal present on the primary winding 606P of multifilar transformer 606 (i.e., at the M3 port) will appear across series-connected secondary windings 606S2 and 606S3 (and therefore at conductor 3 of the 3-conductor logging cable 604 relative to the armor) with amplitude 2A and polarity +P. Normalizing the outputs by dividing by A and representing the outputs as a vector according to (conductor 1, conductor 2, and conductor 3) results in (−1, −1, +2), which is mode M3 in Table 1 above.

In one embodiment, when the surface equipment is receiving in the M3 mode, the current in the signal present on conductor 1 is summed with the current in the signal present on conductor 2 through the secondary windings of multifilar transformer 608 (discussed below) and passes through secondary winding 606S1 of multifilar transformer 606. In one embodiment, the mode M3 voltages present on conductor 1 and conductor 2 are in parallel across the secondary winding 606S1 of multifilar transformer 606. Thus, in one embodiment, the voltage across the primary 606P is the voltage present on conductor 1 (or conductor 2) adjusted by the turn ratio of the 606P/606S1 portion of multifilar transformer 606.

Further, the signal on conductor 3 will appear across the combined windings of secondary windings 606S2 and 606S3, causing a contribution to the signal across primary winding 606P to be one-half of the signal present on conductor 3.

In one embodiment, when the surface equipment is transmitting in the M2 mode, the signal present on the primary winding 608P of multifilar transformer 608 (i.e., at the M2 port) will appear across secondary winding 608S1 (and therefore at conductor 1 of the 3-conductor logging cable 604 relative to the armor) with a second amplitude B (which in one embodiment is equal to first amplitude A), depending on the amplitude of the signal present on the primary winding 608P and the ratio of the number of turns in secondary winding 608S1 to the number of turns in primary winding 608P (in one embodiment, the ratio is 1), and a polarity +P. In one embodiment, the signal present on the primary winding 608P of multifilar transformer 608 (i.e., at the M2 port) will appear across secondary winding 608S2 (and therefore at conductor 2 of the 3-conductor logging cable 604 relative to the armor) with amplitude B and polarity −P. Normalizing the outputs by dividing by B and representing the outputs as a vector according to (conductor 1, conductor 2, and conductor 3) results in (1, −1, 0), which is mode M2 in Table 1 above.

In one embodiment, when the surface equipment is receiving in the M2 mode, the signal present on conductor 1 of the 3-conductor logging cable 604 will be present on the primary 608P adjusted by the turn ratio of the 608P/608S1 portion of multifilar transformer 608. In one embodiment, the signal present on conductor 2 of the 3-conductor logging cable 604 will be present on the primary 608P adjusted by the turn ratio of the 608P/608S2 portion of multifilar transformer 608. In one embodiment, the signal received on conductor 2 is an inverted version of the signal received on conductor 1 so that the effect of multifilar transformer 608, in which secondary winding 608S2 has the opposite polarity of secondary winding 608S1, is that the same signal will appear on primary 608P.

In one embodiment, the surface equipment includes power source 612, which can be an AC power source or a DC power source. In one embodiment, one leg of the power source 612 is connected through multifilar transformers 606 and 608 to all three conductors of the 3-conductor logging cable 604. In one embodiment, the other leg of the power source 612 is connected to the armor. Representing these connections as a vector according to (conductor 1, conductor 2, and conductor 3) results in (1, 1, 1), which is mode M1in Table 1 above.

In one embodiment, the downhole equipment includes a complementary set of multifilar transformers 614 and 616. In one embodiment, multifilar transformer 614 includes a primary winding 614P and two secondary windings 614S1 and 614S2. In one embodiment, the two secondary windings 614S1 and 614S2 are coupled to conductor 1 and conductor 2, respectively, of the 3-wire logging cable 604.

In one embodiment, when the downhole equipment is transmitting in the M3 mode, the signal present on the primary winding 616P of multifilar transformer 616 (i.e., at the M3 port) will appear across secondary winding 616S1 with a polarity −P and a first amplitude A, depending on the amplitude of the signal present on the primary winding 616P and the ratio of the number of turns in secondary winding 616S1 to the number of turns in primary winding 616P (in one embodiment, the ratio is 1). That signal will appear at conductors 1 and 2 through the secondary windings of multifilar transformer 614 (discussed below) at the same amplitude A and polarity P, although the current exiting the secondary winding 616S1 will be divided between conductor 1 and conductor 2. In one embodiment, the signal present on the primary winding 616P of multifilar transformer 616 (i.e., at the M3 port) will appear across series-connected secondary windings 616S2 and 616S3 (and therefore at conductor 3 of the 3-conductor logging cable 604 relative to the armor) with amplitude 2A and polarity +P. Normalizing the outputs by dividing by A and representing the outputs as a vector according to (conductor 1, conductor 2, and conductor 3) results in (−1, −1, +2), which is mode M3 in Table 1 above.

In one embodiment, when the downhole equipment is receiving in the M3 mode, the current in the signal present on conductor 1 is summed with the current in the signal present on conductor 2 through the secondary windings of multifilar transformer 614 (discussed below) and passes through secondary winding 616S1 of multifilar transformer 616. In one embodiment, the mode M3 voltages present on conductor 1 and conductor 2 are in parallel across the secondary winding 616S1 of multifilar transformer 616. Thus, in one embodiment, the voltage across the primary 616P is the voltage present on conductor 1 (or conductor 2 ) adjusted by the turn ratio of the 616P/616S1 portion of multifilar transformer 616.

Further, the signal on conductor 3 will appear across the combined windings of secondary windings 616S2 and 616S3, causing a contribution to the signal across primary winding 616P to be one-half of the signal present on conductor 3.

In one embodiment, when the downhole equipment is transmitting in the M2 mode, the signal present on the primary winding 614P of multifilar transformer 614 (i.e., at the M2 port) will appear across secondary winding 614S1 (and therefore at conductor 1 of the 3-conductor logging cable 604 relative to the armor) with a second amplitude B (which in one embodiment is equal to first amplitude A), depending on the amplitude of the signal present on the primary winding 614P and the ratio of the number of turns in secondary winding 614S1 to the number of turns in primary winding 614P, and a polarity +P. In one embodiment, the signal present on the primary winding 614P of multifilar transformer 614 (i.e., at the M2 port) will appear across secondary winding 614S2 (and therefore at conductor 2 of the 3-conductor logging cable 604 relative to the armor) with amplitude B and polarity −P. Normalizing the outputs by dividing by B and representing the outputs as a vector according to (conductor 1, conductor 2, and conductor 3) results in (1, −1, 0), which is mode M2 in Table 1 above.

In one embodiment, when the downhole equipment is receiving in the M2 mode, the signal present on conductor 1 of the 3-conductor logging cable 604 will be present on the primary 614P adjusted by the turn ratio of the 614P/614S1 portion of multifilar transformer 614. In one embodiment, the signal present on conductor 2 of the 3-conductor logging cable 604 will be present on the primary 614P adjusted by the turn ratio of the 614P/614S2 portion of multifilar transformer 614. In one embodiment, the signal received on conductor 2 is an inverted version of the signal received on conductor 1 so that the effect of multifilar transformer 614, in which secondary winding 614S2 has the opposite polarity of secondary winding 614S1, is that the same signal will appear on primary 614P.

In one embodiment, the power transmitted from the surface equipment in mode M1 appears across a load 618. The currents delivered on conductors 1 and 2 are summed through multifilar transformer 614 and the result is summed with the current delivered on conductor 3 through multifilar transformer 616. The combined currents pass through the load 618 and return to the surface through the armor of the 3-conductor logging cable 604.

In effect, the transformation of signals present on the surface equipment M3 port by multifilar transformer 606 into mode M3 signals is “undone” by the transformation performed by multifilar transformer 616 so that the original signals appear on the downhole equipment M3 port. Similarly, the transformation of signals present on the downhole equipment M3 port by multifilar transformer 616 into mode M3 signals is “undone” by the transformation performed by multifilar transformer 606 so that the original signals appear on the surface equipment M3 port.

In effect, the transformation of signals present on the surface equipment M2 port by multifilar transformer 608 into mode M2 signals is “undone” by the transformation performed by multifilar transformer 614 so that the original signals appear on the downhole equipment M2 port. Similarly, the transformation of signals present on the downhole equipment M2 port by multifilar transformer 614 into mode M2 signals is “undone” by the transformation performed by multifilar transformer 608 so that the original signals appear on the surface equipment M2 port.

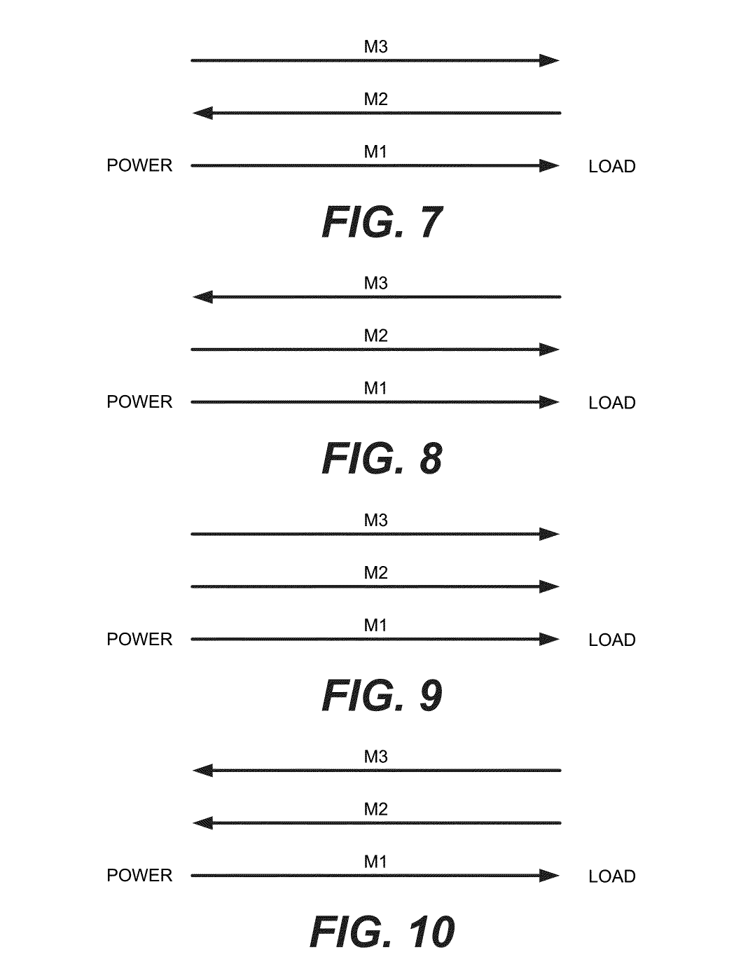

As can be seen in FIGS. 7-10, in one embodiment the 3-conductor logging cable 604 can be used in a number of configurations. Even assuming that mode M1 is devoted to the transmission of power, modes M2 and M3 provide a number of alternative data transmission schemes. In one embodiment shown in FIG. 7, mode M3 is used to transmit data from the surface equipment to the downhole equipment and mode M2 is used to transmit data from the downhole equipment to the surface equipment. In one embodiment shown in FIG. 8, mode M2 is used to transmit data from the surface equipment to the downhole equipment and mode M3 is used to transmit data from the downhole equipment to the surface equipment. In one embodiment shown in FIG. 9, in which there is excessive noise on the 3-conductor logging cable 604, both modes M2 and M3 are used to transmit data from the surface equipment to the downhole equipment. In one embodiment shown in FIG. 10, in which it is desired to increase the reliability of data transmission from the downhole equipment to the surface equipment, both modes M2 and M3 are used for that purpose. In one embodiment (not shown), mode M3, in addition to being used for transmission of power, is also used to transmit data between the surface equipment and the downhole equipment. In one embodiment (not shown), either mode or both modes M2 and M3 simultaneously transmit data bi-directionally between surface and downhole over 3 conductor logging cable 604.

In one embodiment, use of the three transmission modes may be changed depending on the environment in which the surface equipment and the downhole equipment are operating. In one embodiment, an environmental measuring device is used to monitor the environment and a controller makes a selection of the transmission mode configuration using outputs from the environmental measuring device.

For example, in one embodiment shown in FIG. 6 a downlink 620 includes data, such as commands for downhole equipment, to be transmitted from the surface equipment to the downhole equipment. In one embodiment, an uplink 622 includes data, such as sensor data collected downhole, to be transmitted from the downhole equipment to the surface equipment. In one embodiment, a switch 624 provides the ability to selectively connect the downlink 620 to the M2 port and/or the M3 port (in one embodiment, the switch 624 also provides connectivity to the M1 input). In one embodiment, the switch 624 provides the ability to selectively connect the uplink 622 to the M2 port and/or the M3 port.

In one embodiment, a controller 626 sends commands to the switch 624 to configure it. In one embodiment, an environmental measuring device 628, such as a bit error rate detector, measures the bit error rate (“BER”) on the uplink 622 and provides a BER statistic to the controller 626, which then configures the switch to improve the BER. In one embodiment, the controller 262 may be commanded by the data gathering computer 106 through a data link (not shown).

In one embodiment, in the downhole equipment a downlink 630 includes the data transmitted by the surface equipment via the downlink 620. In one embodiment, an uplink 632 includes the data received by the surface equipment as the uplink 622. In one embodiment, a switch 634 provides the ability to selectively connect the downlink 630 to the M2 port and/or the M3 port (in one embodiment, the switch 634 also provides connectivity to the M1 input). In one embodiment, the switch 634 provides the ability to selectively connect the uplink 632 to the M2 port and/or the M3 port.

In one embodiment, a controller 636 sends commands to the switch 634 to configure it. In one embodiment, an environmental measuring device 638, such as a bit error rate detector, measures the bit error rate (“BER”) on the downlink 630 and provides a BER statistic to the controller 636, which then configures the switch to improve the BER. In one embodiment, the controller 636 is commanded by the surface equipment controller 626 or by the data gathering computer 106.

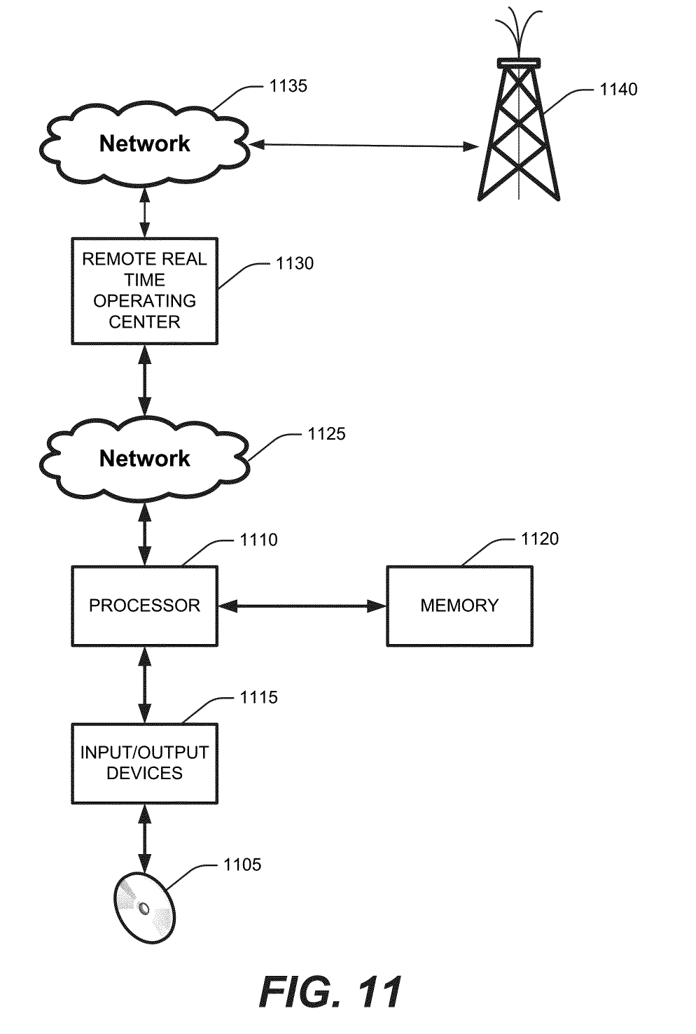

In one embodiment, shown in FIG. 11, the surface equipment controller 626 and/or the downhole equipment controller 636 is controlled by software in the form of a computer program on a non-transitory computer readable media 1105, such as a CD, a DVD, a USB drive, a portable hard drive or other portable memory. In one embodiment, a processor 1110, which may be the same as or included in the surface equipment controller 626, the downhole equipment controller 636, or the data gathering computer 106, reads the computer program from the computer readable media 1105 through an input/output device 1115 and stores it in a memory 1120 where it is prepared for execution through compiling and linking, if necessary, and then executed. In one embodiment, the system accepts inputs through an input/output device 1115, such as a keyboard or keypad, mouse, touchpad, touch screen, etc., and provides outputs through an input/output device 1115, such as a monitor or printer. In one embodiment, the system stores the results of calculations in memory 1120 or modifies such calculations that already exist in memory 1120.

In one embodiment, the results of calculations that reside in memory 1120 are made available through a network 1125 to a remote real time operating center 1130. In one embodiment, the remote real time operating center 1130 makes the results of calculations available through a network 1135 to help in the planning of oil wells 1140 or in the drilling of oil wells 1140.

The word “coupled ”herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. An apparatus comprising:
a logging cable with exactly 3 conductors and an armor;
a first transceiver coupled to the three conductors and the armor of the logging cable,
wherein the first transceiver comprises the following first-transceiver ports:
a first-transceiver mode M1 port,
a first-transceiver mode M2 port, and
a first-transceiver mode M3 port;
wherein the first transceiver couples to:
a first mode on the three conductors and the armor of the logging cable corresponding to a signal on one of the first-transceiver ports,
a second mode on the three conductors and the armor of the logging cable corresponding to a signal on one of the first-transceiver ports, and
a third mode on the three conductors and the armor of the logging cable corresponding to a signal on one of the first-transceiver ports;
wherein the first mode, the second mode, and the third mode are mutually orthogonal; and
wherein the first mode transmits an alternating current over the armor and at least one of the 3 conductors.

2. The apparatus of claim 1 further comprising:
a second transceiver coupled to the three conductors and the armor of the logging cable,
wherein the second transceiver comprises the following second-transceiver ports:
a second-transceiver mode M1 port,
a second-transceiver mode M2 port, and
a second-transceiver mode M3 port;
wherein the second transceiver couples to:
the first mode on the three conductors and the armor of the logging cable,
the second mode on the three conductors and the armor of the logging cable, and
the third mode on the three conductors and the armor of the logging cable.

3. The apparatus of claim 1 wherein:
the signal on the first-transceiver mode M1 port comprises a power signal;
the signal on the first-transceiver mode M2 port comprises a first telemetry signal; and
the signal on the first-transceiver mode M3 port comprises a second telemetry signal.

4. The apparatus of claim 3 wherein:
the first telemetry signal is an uplink; and
the second telemetry signal is a downlink.

5. The apparatus of claim 1 wherein:
the first mode is sequentially used to receive and transmit.

6. The apparatus of claim 1 wherein:
the first mode, second mode, and third mode are induced on the three conductors and the armor of the logging cable according to the following eigen mode table:

| | Signal weight | Signal weight | Signal weight |
|---|---|---|---|
| Conductor | (First Mode) | (Second Mode) | (Third Mode) |
| 1 | 0 | −2 | +1 |
| 2 | +1 | +1 | +1 |
| 3 | −1 | +1 | +1 |

7. The apparatus of claim 1 wherein:
the first transceiver comprises a switch whereby:
the first-transceiver mode M1 port is selectively coupleable to the first mode or the second mode on the three conductors and the armor of the logging cable.

8. The apparatus of claim 7 wherein the first-transceiver mode M2 port is selectively coupleable to the first mode or the second mode on the three conductors and the armor of the logging cable.

9. The apparatus of claim 7 further comprising:
a controller to control the switch.

10. The apparatus of claim 7 further comprising:
a bit-error-rate detector with an output that is used to select whether the first-transceiver mode M1 port is coupled to the first mode or the second mode.

11. A transceiver comprising:
the following first-transceiver input ports:
a first-transceiver mode M1 port,
a first-transceiver mode M2 port, and
a first-transceiver mode M3 port;
an logging cable interface for a logging cable with exactly 3 conductors and an armor;
wherein the transceiver generates signals on the logging cable interface to create:
a first mode corresponding to a signal on one of the first-transceiver ports,
a second mode corresponding to a signal on one of the first-transceiver ports, and
a third mode corresponding to a signal on one of the first-transceiver ports;
wherein the first mode, the second mode, and the third mode are mutually orthogonal; and
wherein the first mode generates an alternating current over the armor and at least one of the 3 conductors.

12. The transceiver of claim 11 wherein:
the first mode, second mode, and third mode correspond to the following eigen mode table:

| | Signal weight | Signal weight | Signal weight |
|---|---|---|---|
| Conductor | (First Mode) | (Second Mode) | (Third Mode) |
| 1 | 0 | −2 | +1 |
| 2 | +1 | +1 | +1 |
| 3 | −1 | +1 | +1 |

13. The transceiver of claim 11 further comprising:
a switch to selectively couple the first-transceiver mode M1 port to the first mode or the second mode.

14. The apparatus of claim 13 wherein the switch selectively couples the first-transceiver mode M2 port to the first mode or the second mode.

15. A method comprising:
coupling a first signal to a first mode of a logging cable having exactly 3 conductors and an armor;
coupling a second signal to a second mode of the logging cable; and
coupling a third signal to a third mode of the logging cable;
wherein the first mode, the second mode, and the third mode are mutually orthogonal; and
wherein the first mode comprises an alternating current signal transmitted over the armor and at least one of the 3 conductors.

16. The method of claim 15 further comprising:
receiving a command, the command specifying that the second signal be coupled to the second mode and that the third signal be coupled to the third mode.

17. The method of claim 15 wherein:
the first signal comprises a power signal;
the second signal comprises a telemetry signal; and
the third signal comprises a telemetry signal.

18. The method of claim 15 wherein:
the second signal comprises an uplink signal that travels in a first direction along the logging cable; and
the third signal comprises a downlink signal that travels in a second direction opposite the first direction.

19. The method of claim 15 further comprising:
determining that the bit error rate of the third signal is higher than a threshold; and, in response:
commanding the second signal to be coupled to the third mode of the logging cable; and
commanding the third signal to be coupled to the second mode of the logging cable.

20-21. (canceled)
